(19) United States
(12) Patent Application Publication
(10) Pub. No.: US 2021/0157715 A1
(43) Pub. Date: May 27, 2021

(54) MANAGE MULTI-TEAM AND MULTI-SPRINT PROJECTS VIA COGNITIVE COMPUTING

(71) Applicant: International Business Machines Corporation, Armonk, NY (US)

(72) Inventors: Leonard Scott Hand, Red Creek, NY (US); Eric Lee Gose, Dallas, TX (US); Christine Engeleit, Cortlandt Manor, NY (US)

(21) Appl. No.: 16/693,323

(22) Filed: Nov. 24, 2019

(51) Int. Cl. G06F 11/36; G06Q 10/06; G06F 40/40

(52) U.S. Cl. CPC G06F 11/3688; G06F 40/40; G06Q 10/06313

(57) ABSTRACT

The approach for managing multi-sprint backlog is presented. The approach includes receiving one or more issues associated with software development and scoring the one or more issues. The approach also includes determining if the score associated with the one or more issues is above a first threshold and enriching the one or more issues if the issues is above the threshold. The approach recommends a queue based on the enriched of the one or more issues, team parameters and queue parameters and prioritizing the one or more issues in the queue based on priority parameters. The approach calculates a backlog value based on sprint factors associated with the one or more issues; If the backlog values meets a threshold, then the approach creates a sprint plan for the team.

### BACKGROUND

The present invention relates generally to the field of computer software, and more particularly to leveraging AI (Artificial Intelligence) to agile software development.

Software development Life Cycle (SDLC), specifically, Agile SDLC is a unique development method where requirements and solutions are intertwined in a collaborative effort. The efforts involves a self-organizing and cross-functional teams associated with developers and customers but end users as well.

The Agile software development methodology utilizes specific terminologies (e.g., backlogs, cross functioning team, continuous integration, etc.) including well ubiquitous ones such as scrum and sprint. Most Agile SDLC breaks the work into small increments that minimizes the front-end planning and design work. Hence, iterations/sprints are usually one to four weeks which includes cross functional team. Multiple iterations may be required before a full release of the product. Furthermore, an emphasis on face-to-face communication within the teams are a cornerstone of methodology.

### SUMMARY

Aspects of the present invention disclose a computer-implemented method, computer program product, and computer system for multi-sprint backlog management. The computer implemented method includes receiving, by one or more processor, one or more issues associated with software development; scoring, by the one or more processor, the one or more issues; determining, by the one or more processor, if the score associated with the one or more issues is above a first threshold; responsive to the one or more items is above the threshold, enriching, by the one or more processor, the one or more issues; recommending, by the one or more processor, a queue based on the enriched of the one or more issues, team parameters and queue parameters; prioritizing, by the one or more processor, the one or more issues in the queue based on priority parameters; calculating, by the one or more processor, backlog value based on sprint factors associated with the one or more issues; determining, by the one or more processor, if the calculated backlog value is above a second threshold; and responsive to the calculated backlog value is above the second threshold, creating, by the one or more processor, a sprint plan based on sprint parameters.

In another embodiment, the computer program product includes one or more computer readable storage media and program instructions stored on the one or more computer readable storage media, the program instructions comprising: program instructions to receive one or more issues associated with software development; program instructions to score the one or more issues; program instructions to determine if the score associated with the one or more issues is above a first threshold; responsive to the one or more items is above the threshold, program instructions to enrich the one or more issues; program instructions to recommend a queue based on the enriched of the one or more issues, team parameters and queue parameters; program instructions to prioritize the one or more issues in the queue based on priority parameters; program instructions to calculate backlog value based on sprint factors associated with the one or more issues; program instructions to determine if the calculated backlog value is above a second threshold; and responsive to the calculated backlog value is above the second threshold, program instructions to create a sprint plan based on sprint parameters.

In another embodiment, the computer system includes one or more computer processors; one or more computer readable storage media; program instructions stored on the one or more computer readable storage media for execution by at least one of the one or more computer processors, the program instructions comprising: program instructions to receive one or more issues associated with software development; program instructions to score the one or more issues; program instructions to determine if the score associated with the one or more issues is above a first threshold; responsive to the one or more items is above the threshold, program instructions to enrich the one or more issues; program instructions to recommend a queue based on the enriched of the one or more issues, team parameters and queue parameters; program instructions to prioritize the one or more issues in the queue based on priority parameters; program instructions to calculate backlog value based on sprint factors associated with the one or more issues; program instructions to determine if the calculated backlog value is above a second threshold; and responsive to the calculated backlog value is above the second threshold, program instructions to create a sprint plan based on sprint parameters.

### BRIEF DESCRIPTION OF THE DRAWINGS

FIG. 1 is a functional block diagram illustrating a topology of an agile environment, designated as 100, in accordance with an embodiment of the present invention;

FIG. 2 is a functional block diagram illustrating agile component in accordance with an embodiment of the present invention;

FIG. 3 is a flowchart illustrating the operation of an agile management system, designated as 300, in accordance with an embodiment of the present invention; and

FIG. 4 depicts a block diagram, designated as 400, of components of a server computer capable of executing the agile management system within the agile environment, of FIG. 1, in accordance with an embodiment of the present invention.

### DETAILED DESCRIPTION

Embodiments of the present invention provides an efficient and intelligent approach of managing project (i.e., software development) across multiple teams with large and complex (i.e., multi-sprint) backlogs (i.e., projects with new function as well as defect management). For example, with multiple teams across multiple latitudes it becomes a challenge to prioritize the work and properly distribute across the teams. Furthermore, it is more difficult when one wants to play what-if games for optimal sprint assignment and backlog management has become a daunting task for the scrum master. Thus, the approach can overcome the previously mentioned issues. The approach accomplishes the management task by dividing the project into teams and the backlog into queues. The queues are then distributed across the teams based on a percentage of the team velocity and distribution methods.

Other embodiments of the present invention has some of the following advantages in overcoming the difficulties associated with agile project management: a) allows for the Scrum Master to quickly add task/issues/defects/etc. and assign them to the appropriate sprint team, b) allows for the Scrum master to exercise “what-if” scenarios by easily modifying adjustment points (e.g., velocity, percentages, priorities, etc.) and view the results immediately and c) allows for cross team relative backlog distribution while ensuring backlog integrity.

In another embodiments of the present invention has some of the following advantages in overcoming the difficulties associated with agile project management: a) saves a significant amount of time in backlog planning, b) enforces disciplines and consistency across backlog sprint assignments and c) improve the sprint velocity due to the more organized backlog planning and sprint assignments.

A detailed description of embodiments of the claimed structures and methods are disclosed herein; however, it is to be understood that the disclosed embodiments are merely illustrative of the claimed structures and methods that may be embodied in various forms. In addition, each of the examples given in connection with the various embodiments is intended to be illustrative, and not restrictive. Further, the figures are not necessarily to scale, some features may be exaggerated to show details of particular components. Therefore, specific structural and functional details disclosed herein are not to be interpreted as limiting, but merely as a representative basis for teaching one skilled in the art to variously employ the methods and structures of the present disclosure.

References in the specification to “one embodiment”, “an embodiment”, “an example embodiment”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments, whether or not explicitly described.

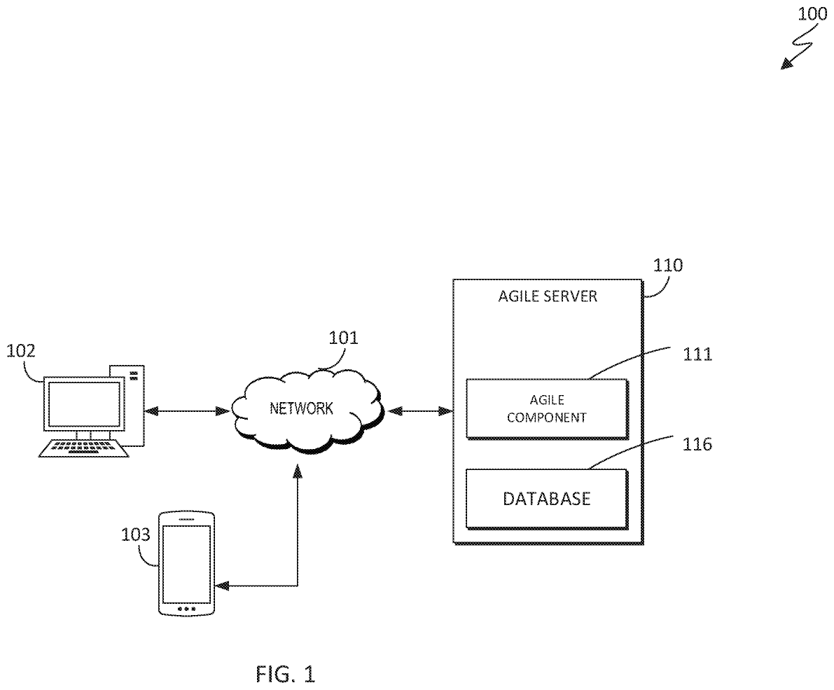

FIG. 1 is a functional block diagram illustrating a topology of an agile environment, designated as 100, in accordance with an embodiment of the present invention. FIG. 1 provides only an illustration of one implementation and does not imply any limitations with regard to the environments in which different embodiments may be implemented. Many modifications to the depicted environment may be made by those skilled in the art without departing from the scope of the invention as recited by the claims.

Agile environment 100 includes client computing device 102, mobile computing device 103 and agile server 110. All (e.g., 102 and 110) elements can be interconnected over network 101.

Network 101 can be, for example, a telecommunications network, a local area network (LAN), a wide area network (WAN), such as the Internet, or a combination of the three, and can include wired, wireless, or fiber optic connections. Network 101 can include one or more wired and/or wireless networks that are capable of receiving and transmitting data, voice, and/or video signals, including multimedia signals that include voice, data, and video information. In general, network 101 can be any combination of connections and protocols that can support communications between agile server 110 and other computing devices (not shown) within agile environment 100. It is noted that other computing devices can include, but are not limited to, client computing device 102 and any electromechanical devices capable of carrying out a series of computing instructions.

Client computing device 102 represents a network capable mobile computing device that may receive and transmit confidential data over a wireless network. Mobile computing device 102 can be a laptop computer, tablet computer, netbook computer, personal computer (PC), a personal digital assistant (PDA), a smart phone, smart watch (with GPS location) or any programmable electronic device capable of communicating with server computers (e.g., agile server 110) via network 101, in accordance with an embodiment of the present invention.

Mobile computing device 103 represents a network capable mobile computing device that may receive and transmit confidential data over a wireless network. Mobile computing device 103 can be a laptop computer, tablet computer, netbook computer, personal computer (PC), a personal digital assistant (PDA), a smart phone, smart watch (with GPS location) or any programmable electronic device capable of communicating with server computers (e.g., agile server 110) via network 101, in accordance with an embodiment of the present invention.

Agile server 110 can be a standalone computing device, a management server, a web server, a mobile computing device, or any other electronic device or computing system capable of receiving, sending, and processing data. In other embodiments, agile server 110 can represent a server computing system utilizing multiple computers as a server system, such as in a cloud computing environment. In another embodiment, agile server 110 can be a laptop computer, a tablet computer, a netbook computer, a personal computer (PC), a desktop computer, a personal digital assistant (PDA), a smart phone, or any other programmable electronic device capable of communicating other computing devices (not shown) within 100 via network 101. In another embodiment, agile server 110 represents a computing system utilizing clustered computers and components (e.g., database server computers, application server computers, etc.) that act as a single pool of seamless resources when accessed within agile environment 100.

Agile server 110 includes agile component 111 and database 116.

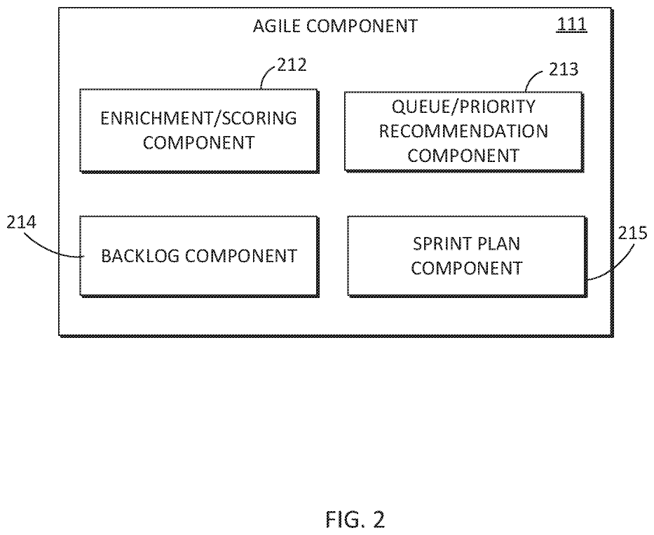

Agile component 111 enables the present invention to communicate, manage and organize the software development life cycle to all relevant parties through the use of cognitive computing. It is noted that cognitive computing can be utilized throughout the entire process (i.e., beginning to end) or part of the process/component of the system. Agile component 111 will be described in greater details in regard to FIG. 2.

Database 116 is a repository for data used by agile component 111. Database 116 can be implemented with any type of storage device capable of storing data and configuration files that can be accessed and utilized by agile server 110, such as a database server, a hard disk drive, or a flash memory. Database 116 uses one or more of a plurality of techniques known in the art to store a plurality of information. In the depicted embodiment, database 116 resides on agile server 110. In another embodiment, database 116 may reside elsewhere within agile environment 100, provided that agile component 111 has access to database 116. Database 116 may store information associated with, but is not limited to, corpus knowledge of sprint plans rules, relationship rules, backlog parameters and priority parameters.

FIG. 2 is a functional block diagram illustrating agile component 111 in accordance with an embodiment of the present invention. In the depicted embodiment, agile component 111 includes enrichment/scoring component 212, queue/priority component 213, backlog component 214 and sprint plan component 215. It is noted that agile component 111 can be utilized in a centralized or de-centralized software system with an application (front end interface) on mobile computing devices and/or a backend on the server.

As is further described herein below, enrichment/scoring component 212, of the present invention provides the capability of enriching datasets associated with various items (i.e., issues). Enriching items means that the items cognitively categorized (i.e., natural language understanding) to tag and enhance the context of the item. Item enrichment should occur once, and then items are validated and scored. However, it is possible for enrichment to occur before and after scoring. After items are categorized, it allows agile component 111 to make a queue recommendation.

In another embodiment, enrichment/scoring component 212 can score and/or res-core issues based on scoring factors. Scoring means that the embodiments can assign a value that represents the complexity or size of the issue (i.e., not a type of grade in terms of quality). In traditional settings this might be a time estimate (i.e., “This task should take 4 hours to complete”). In scrum, the tendency is to use relative scores since such exact time estimates tend to be impossible to accurately predict in software development.

Two common scoring methods are the “t-shirt method” (determine if a task is X-Small, Small, Medium, Large, X-Large) or using Fibonacci sequence (possible point values of: 1, 2, 3, 5, 8, 13, 21, etc.). It can be up to the scrum team (or scrum master) to gauge the complexity and size of the issue and give it a score. However, information is needed before determining a score, information such as, a well-defined issue with an appropriate amount of info about function and non-functional requirements, design specs, etc. (i.e., it's all dependent on the nature of the issue). Furthermore, a score can range from 1 to 100. A user selectable threshold can be used to delineate what is deemed “acceptable/good” or “not acceptable/not good.” Thus, the threshold can be set at 70 where anything below 70 is considered “not acceptable.”

It is noted that scoring issues/items can be done before enriching items or can be done again (i.e., items can be re-scored) to “enrich” those items. The scoring factors can include, but it is not limited to, a maturity of issue, context, difficulty level, UI/front end programming, scope and tagging. UI/front end programming means that scoring is based on whether the programming is categorized as front-end or backend programming. Difficulty level can range from “0” (least difficult) to “10” (most difficult). It is noted that difficulty level can be determined by cognitive computing or a human. For example, a cognitive computing can be trained with NLU/NLP (natural language understanding/natural language processing) to develop a context. The resulting context can be used to indicate the difficulty of Context A with a high relevance score indicting a difficult task. Tagging means that assigning boundaries to the issues. For example, tagging the issue with “ISMICROSERVICE” could help with error checking. Other tags such as “SSO,” “ENCRYPT” and “SCALE-HORIZON” can be used and the tagging terminology and it's intended significance and meaning can be predetermined by an administrator before system setup and installation. It is noted that tagging can be done by a human and/or a cognitive computing scoring. The scope can be interpreted as context of the issue. For example, if the issue has one human actor and the calculated based would be smaller than the calculated based issue with five human actors and two system actors. It is noted that scoring can be enterprise wide level or individually.

As is further described herein below, queue/priority recommendation component 213, of the present invention provides the capability managing the queue process. The agile component 111 can use the “item enrichment” process to cognitively select the appropriate queue for the item. Each queue has its context created when the queue is initialized. As items are added to the queue by the scrum master (overriding the recommendations), the queue context is upgraded. For example, queues can be labeled “CORPUS,” “SOE” or “CRITICAL UPDATE.” The “CORPUS” queue would represent work for backend system or integration work, and the “SOE” (System of Engagement, the front-end system) would represent work where the assignee would need to have a skillset doing UI-related tasks. The items are further broken down into backlog (planned and expected work items) and defects (regressions or bugs). The “CRITICAL UPDATE” queue are for critical items, which would be for exceptional items that need immediate resolution. It is noted that the examples of queues previously listed resembles a common way project managers/product owners/scrum masters might categorize the work. However, it is up to the discretion of the owner/admin/managers to setup meaningful queue names and purpose based on specific project. Additionally, the number of queues and types of breakdowns can be just as varied as the different types of projects or teams that exist.

In another embodiment, items can be added to the desirable queue by leveraging cognitive computing technology. And cognitive computing can be used to process natural language and make recommendation for items to be placed in a certain queue. Furthermore, natural language processing via cognitive computing can be leveraged to understand context (e.g., key concepts and key words) so that item placement recommendations can be made (i.e., recommend which queue should be assigned to which team). For example, the agile component 111 can determine which team should process which queue as the agile component 111 recognizes that certain categories/classifications of tasks are done far more effectively by one team versus another). Additionally, the agile component 111 could recommend an item usually reserved for queue 1 and team A be assigned to queue 2 handled by team B for the sake of comparing expected timeframe/effort in the hopes of improving recommendations for future items. It is further noted that the agile component 111 can recommend total distribution of queues over teams to meet a particular objective.

In another embodiment, queue/priority component 213 can prioritize items already assigned to a queue, by leveraging cognitive computing, in the queue based on the priority parameters (e.g., user created rules, goals, and other relationships, etc.). For example, items added to a queue are tentatively prioritized (i.e., awaiting final approval from the scrum master) based on those priority parameters, queue parameters (e.g., queue item status, queue item points, etc.) and team parameters (e.g., teams and team members). Queue item status can include the following: a) READY—The item can be worded on and has no relationships, b) READY_PRECONDITION—Item is ready but has a precondition that must be done before this can be started. An item in this state can be added to a sprint as long as all the preconditions are also in the sprint and c) STANDBY—This item is on hold and is not ready for distribution to the team (this could be because it exceeds effective velocity or has some other blocker. Note: a precondition item is not considered a blocker). Queue item points are points assigned to the item. It is noted that queue can be prioritized by the cognitive computing component of the agile component 111 instead of waiting on users. Team members include teams (i.e., there are instances where a queue will be distributed over multiple teams) and team members (optionally used if tracking of individual velocity is desired). Individual velocity (an indication of capability) serves an initial assignment recommendation.

As is further described herein below, backlog component 214 of the present invention provides, in real time, the capability of calculating a backlog value. Based on sprint parameters such as, velocity, distribution, priority and methodology, the sprints backlog value is calculated by the agile component 111, leveraging cognitive computing. Backlog component 214 can also predict/project on the finishing time, which can help with long-term planning. A calculated backlog value can be represented by a numerical value with a range pre-defined by the user and/or system administrator. For example, a user may setup a range of 1 to 100 for backlog value. A pre-defined threshold may be used to determine if the score of the calculated backlog is valid and/or acceptable to proceed with the sprint plan calculation (which would lead to creation). A threshold may be set to 70 wherein any calculated backlog value scored before a 70 is deemed not acceptable for a sprint plan calculation.

As is further described herein below, sprint plan component 215 of the present invention provides the capability of creating plans for sprint. Sprint plan component 215 can create several sprint plans, by leveraging cognitive computing, after factoring in queue parameters, calculated backlog score and sprint parameters (e.g., velocity, percentage, effective velocity, method of distribution, queue parameters, teams, and team members). Sprint plans, generally include backlog items (i.e., from the queues) that the team will work on during the sprint session and discusses initial planning for completion of the backlog items. Furthermore, the sprint plan can include details such as identifying tasks for the backlog items including any dependencies between the items. The customized sprint plan for each team member can also be created where the plan has itemized tasks for each team member. The velocity parameter refers to the team's velocity. Percentage refers the percentage of the velocity of the team that is used for the queue. Effective velocity is the result of multiplying velocity by percentage. Method of distribution can include the following: “FIFO-ONLY,” “FIFO-FILLTO VELOCITY,” “FIFO-OVERCOMMIT”, “FIFO-LARGEFIRST” and “FIFO-FAVOROLD.” Table 1 illustrate the meaning of the terminology associated with method of distribution. Sprint plan component 215 can take user input on approving the final plan (amongst the other sprint plans) or the final sprint plan can be selected by cognitive computing. It is noted that not all final sprint plant needs to be accepted/validated by the scrum master.

Once the sprint plan is approved then it can be disseminated to all sprint leaders. For example, the plan can be printed (e.g., spreadsheet format or text data) so that all sprint leaders will have their scope for the sprint. In another example, the generic sprint plan can be emailed to all team members. Alternatively, a customized sprint plan with a breakdown of next steps based on the role of the team members can be emailed to each individual team member.

TABLE 1
Method of Distribution

| | |
|---|---|
| FIFO-ONLY | Process items in order until you reach an item you cannot |
| | (Run out of velocity points) then stop |
| FIFO-FILLTOVELOCITY | Process items, if you must skip an item because its velocity |
| | is too high proceed down the list to find items that will fit in |
| FIFO-OVERCOMMIT | Process items until you use up all the velocity (even if the |
| | last item will exceed the total) |
| FIFO-LARGEFIRST | If an item representing a large portion of the available |
| | velocity |
| FIFO-FAVOROLD | By keeping track of issue creation date, we can give special |
| | consideration to items that have been sitting lower on the |
| | queue for longer periods of time. This could help with the |
| | perceived effectiveness of the application development in |
| | response to user feedback. Issues that are reported but not |
| | deemed critical can sit in the backlog for months, always |
| | superseded by newer more important updates. This |
| | provides a mechanism to favor items like this (in the |
| | circumstances where an entirely new queue isn't |
| | warranted). |

The following table illustrates the data elements that will be used during the creation and editing of project teams.

TABLE 2
Project Teams

| Data Element | Type | Description |
|---|---|---|
| name | char* | Human-readable name for this team |
| id | UUID | Unique identifier |
| description | char* | Human-readable description |
| queues | array | This is an array of queue UUIDs that this team is addressing |
| context | array | This is the understanding of the team, allowing a queue to be |
| | | recommended to a team as a queue can made up of a small |
| | | number of items and may have a lifetime of one sprint. |
| velocity | array | This is an array of velocities for both historical (predicated and |
| | | actuals) and predictive future use. This array also has a pointer to |
| | | the sprint assignment. |
| members | array | Optionally one can keep track of team members and their |
| | | personal velocity. With this we can distribute the load over the |
| | | team members. Note: generating the sprint plan can include |
| | | initial assignments. This disclosure does not go into details but |
| | | does not preclude member recommendations |

The following table illustrates the data elements that can be used during the creation and editing of backlog queues:

TABLE 3
Backlog queues

| Data Element | Type | Description |
|---|---|---|
| name | char* | Human-readable name for this queue |
| id | UUID | Unique Identifier |
| description | char* | Human-readable description (This is analyzed to help |
| | | determine the context and key words/phrases of the queue - to |
| | | be used by the recommendation process) |
| rules | ENUM | Valid rule types |
| | | FIFO-ONLY - Process items in order until you reach an item |
| | | you cannot (Run out of velocity points) then stop |
| | | FIFO-FILLTOVELOCITY - Process items, if you must skip |
| | | an item because its velocity is too high proceed down the list |
| | | to find items that will fit in |
| | | FIFO-OVERCOMMIT - Process items until you use up all the |
| | | velocity (even if the last item will exceed the total) |
| | | FIFO-LARGEFIRST - If an item representing a large portion |
| | | of the available velocity |
| | | FIFO-FAVOROLD - By keeping track of issue creation date, |
| | | we can give special consideration to items that have been |
| | | sitting lower on the queue for longer periods of time. This |
| | | could help with the perceived effectiveness of the application |
| | | development in response to user feedback. Issues that are |
| | | reported but not deemed critical can sit in the backlog for |
| | | months, always superseded by newer more important updates. |
| | | This provides a mechanism to favor items like this (in the |
| | | circumstances where an entirely new queue isn't warranted). |
| context | array | An array of context tags (created by both humans and the |
| | | system) to help the recommendation process place the |
| | | appropriate backlog items in this queue |
| teams | array | This is an array of team UUID. Normally this will be one or |
| | | zero teams. But on occasion we may wish to distribute a |
| | | queue across multiple teams. |
| backlog | array | And array of meta data objects that reference a user story, |
| | | issue or task. The actual story/issue/task would be stored in |
| | | another system. |

Once calculations are complete then sprint planning sheets for each team are produced.

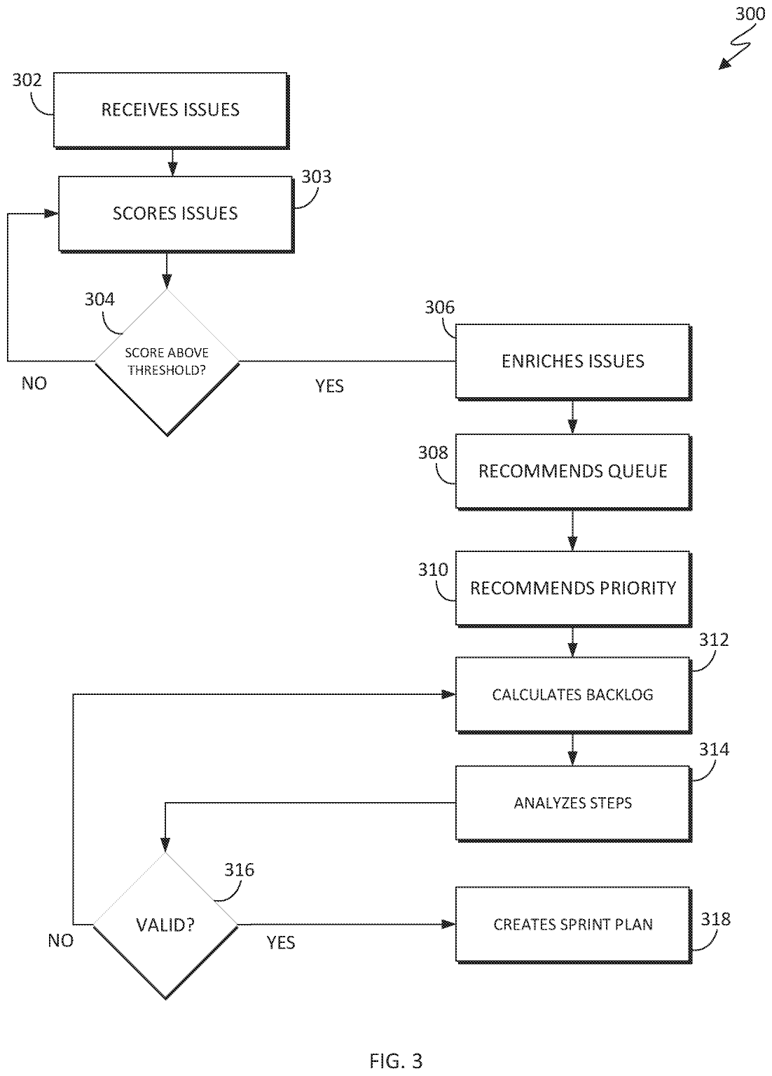

FIG. 3 is a flowchart illustrating the operation of an agile environment 100, designated as 300, in accordance with an embodiment of the present invention.

Agile component 111 receives an issue (step 302). In an embodiment, agile component 111 received an issue to be scored. For example, an issue is sent to a scrum master (i.e., development). It is noted that issues can be sent (i.e., submitted) manually or can be automated.

Agile component 111 scores an issue (step 303). In an embodiment, agile component 111, through enrichment/scoring component 212, scores the received issues. For example, based on the complexity of the issue, agile component 111 may assign ISSUE A, a score of 90.

In another embodiment, agile component 111 enriches the data or metadata for an issue before it can be scored, or the score might be so large that it needs to be broken down into further subtasks. It is noted that enrichment can be done via cognitive computing in this step.

Agile component 111 determines if the score of the issue is above a threshold (decision block 304). In an embodiment, agile component 111 received the score of an issue from the previous step (step 303). Currently the scoring threshold is set to 70. Thus, if agile component 111 scores the issue (i.e., ISSUE A) as a “90” then agile component 111 proceeds to step 306 (“YES” branch, decision block 304). However, if agile component 111 scores the issue (i.e., ISSUE A) at “60” then agile component returns to step 302 (“No” branch, decision block 304). It is noted that scoring of issues can be done on an enterprise wide scale.

Agile component 111 enriches the issue (step 306). In an embodiment, agile component 111 through enrichment/scoring component 212 enriches the received issue/items by re-scoring. Agile component 111 re-scores the issue via cognitive computing, based on scoring factors. These scoring factors can include, but are not limited to, a maturity of the issue, context (i.e., derived from cognitive computing and the language being used. For example, agile component 111 determines that the issue (ISSUE A scored at a “90”) is not easily discernible based on the scoring factors of context (e.g., size and complexity) and tagging (i.e., calculated by cognitive computing). Thus, that issue (i.e., ISSUE A) may receive (via a re-scoring) lower score of 65 instead of the original 90.

It is noted that a first enrichment step can occur before scoring in another alternative embodiment. For example, after step 302, agile component 111 can enrich the issue (i.e., ISSUE A) before scoring (i.e., before decision block 304).

Agile component 111 recommends the queue (step 308). In an embodiment, agile component 111 through queue/priority recommendation component 213 selects the appropriate queue for the issues/items. Each queue has its context created when the queue is initialized. As items are added to the queue by the scrum master (overriding the recommendations), the queue context is upgraded.

Agile component 111 recommends the priority (step 310). In an embodiment, agile component 111 through queue/priority recommendation component 213 selects the appropriate priority for the issues/items. Based on the pre-defined priority parameters (e.g., goals, rules, relationships etc.), items added to a queue are tentatively prioritized (awaiting final approval from the scrum master) by cognitive computing. It is noted that predefine parameters are adjustable and dynamic.

Agile component 111 calculates the backlog (step 312). In an embodiment, agile component 111 through backlog component 214 calculates the backlog associated with the issues/items. Based on the pre-define backlog parameters (e.g., velocity, distribution, priority, and method of sprints, etc.), backlogs are calculated. It is noted that predefine parameters are adjustable and dynamic. The agile component 111 can forecast projections associated with the finishing time so that longer-term planning can be accomplished.

Agile component 111 analyzes the steps (step 314). In an embodiment, agile component 111, through the scrum muster, determines the final sprint plan based on the previously analyzed steps, the steps can comprise of, but it is not limited to, a) item enrichment, b) queue prioritization/recommendation and c) backlog calculation.

Agile component 111 determines if the steps are valid (decision block 316). In an embodiment, agile component 111, leveraging cognitive computing and/or the scrum master input, can determine if the final sprint plan is adequate based on backlog and priority parameters. If agile component 111 determines that the sprint plan is adequate (“YES” branch, decision block 316) then the agile component 111 proceeds to step 318. However, if agile component 111 determines that the sprint plan is not adequate (“NO” branch, decision block 316) then agile component 111 returns to step 312.

Agile component 111 creates the sprint plan (step 318). In an embodiment, agile component 111, creates the final sprint plan. The final sprint plan can include tasks (of backlog items) for each team members. For example, once the plan is approved it can print so that all sprint leaders will have their scope for the sprint. This can be in any format the team needs from spreadsheets to text data to program enabled (i.e., software application).

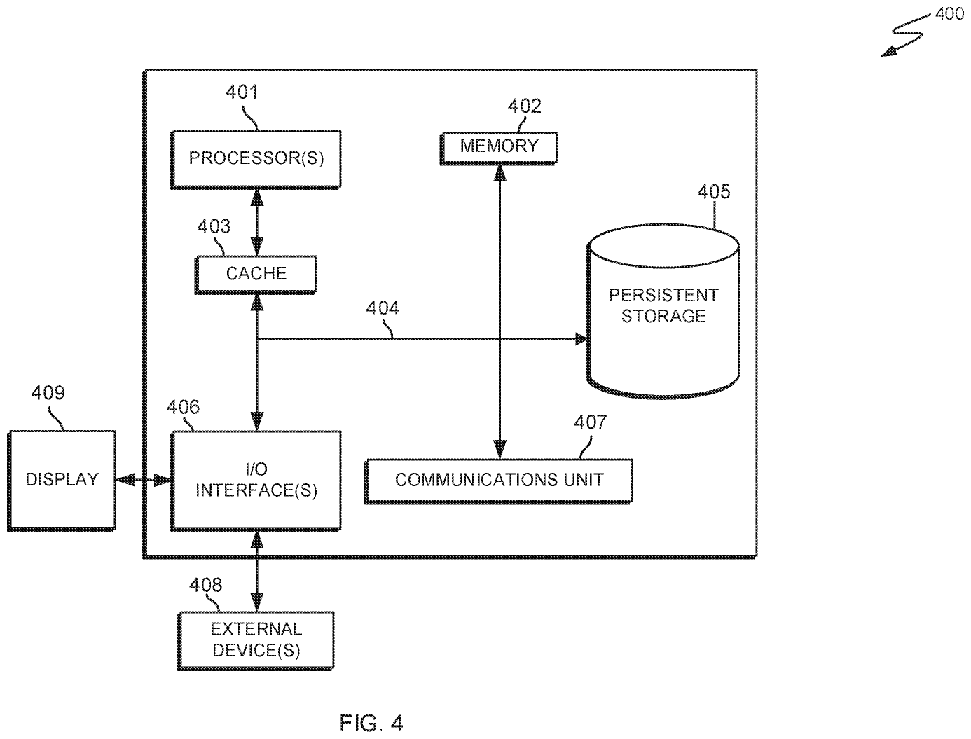

FIG. 4 depicts a block diagram, designated as 400, of components of an intelligence component 111 application, in accordance with an illustrative embodiment of the present invention. It should be appreciated that FIG. 4 provides only an illustration of one implementation and does not imply any limitations with regard to the environments in which different embodiments may be implemented. Many modifications to the depicted environment may be made.

FIG. 4 includes processor(s) 401, cache 403, memory 402, persistent storage 405, communications unit 407, input/output (I/O) interface(s) 406, and communications fabric 404. Communications fabric 404 provides communications between cache 403, memory 402, persistent storage 405, communications unit 407, and input/output (I/O) interface(s) 406. Communications fabric 404 can be implemented with any architecture designed for passing data and/or control information between processors (such as microprocessors, communications and network processors, etc.), system memory, peripheral devices, and any other hardware components within a system. For example, communications fabric 404 can be implemented with one or more buses or a crossbar switch.

Memory 402 and persistent storage 405 are computer readable storage media. In this embodiment, memory 402 includes random access memory (RAM). In general, memory 402 can include any suitable volatile or non-volatile computer readable storage media. Cache 403 is a fast memory that enhances the performance of processor(s) 401 by holding recently accessed data, and data near recently accessed data, from memory 402.

Program instructions and data (e.g., software and data x10) used to practice embodiments of the present invention may be stored in persistent storage 405 and in memory 402 for execution by one or more of the respective processor(s) 401 via cache 403. In an embodiment, persistent storage 405 includes a magnetic hard disk drive. Alternatively, or in addition to a magnetic hard disk drive, persistent storage 405 can include a solid state hard drive, a semiconductor storage device, a read-only memory (ROM), an erasable programmable read-only memory (EPROM), a flash memory, or any other computer readable storage media that is capable of storing program instructions or digital information.

The media used by persistent storage 405 may also be removable. For example, a removable hard drive may be used for persistent storage 405. Other examples include optical and magnetic disks, thumb drives, and smart cards that are inserted into a drive for transfer onto another computer readable storage medium that is also part of persistent storage 405. Agile component 111 can be stored in persistent storage 405 for access and/or execution by one or more of the respective processor(s) 401 via cache 403.

Communications unit 407, in these examples, provides for communications with other data processing systems or devices. In these examples, communications unit 407 includes one or more network interface cards. Communications unit 407 may provide communications through the use of either or both physical and wireless communications links. Program instructions and data (e.g., Agile component 111) used to practice embodiments of the present invention may be downloaded to persistent storage 405 through communications unit 407.

I/O interface(s) 406 allows for input and output of data with other devices that may be connected to each computer system. For example, I/O interface(s) 406 may provide a connection to external device(s) 408, such as a keyboard, a keypad, a touch screen, and/or some other suitable input device. External device(s) 408 can also include portable computer readable storage media, such as, for example, thumb drives, portable optical or magnetic disks, and memory cards. Program instructions and data (e.g., Agile component 111) used to practice embodiments of the present invention can be stored on such portable computer readable storage media and can be loaded onto persistent storage 405 via I/O interface(s) 406. I/O interface(s) 406 also connect to display 409.

Display 409 provides a mechanism to display data to a user and may be, for example, a computer monitor.

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration but are not intended to be exhaustive or limited to the embodiments disclosed. Many modifications and variations will be apparent to those of ordinary skill in the art without departing from the scope and spirit of the invention. The terminology used herein was chosen to best explain the principles of the embodiment, the practical application or technical improvement over technologies found in the marketplace, or to enable others of ordinary skill in the art to understand the embodiments disclosed herein.

What is claimed is:

1. A computer-implemented method for improving multi-sprint backlog management, the method comprising:
receiving, by one or more processor, one or more issues associated with software development;
scoring, by the one or more processor, the one or more issues;
determining, by the one or more processor, if the score associated with the one or more issues is above a first threshold;
responsive to the one or more items is above the first threshold, enriching, by the one or more processor, the one or more issues;
recommending, by the one or more processor, a queue based on the enriched one or more issues, team parameters and queue parameters;
prioritizing, by the one or more processor, the enriched the one or more issues in the queue based on priority parameters;
calculating, by the one or more processor, backlog value based on sprint factors associated with the enriched one or more issues;
determining, by the one or more processor, if the calculated backlog value is above a second threshold; and
responsive to the calculated backlog value is above the second threshold, creating, by the one or more processor, a sprint plan based on sprint parameters.

2. The computer-implemented method of claim 1, wherein enriching the one or more issues further comprises:
tagging, by the one or more processor, the one or more issues with context based on NLP (natural language processing).

3. The computer-implemented method of claim 1, wherein scoring the one or more issues further comprises:
assigning, by the one or more processor, a value to each of the one or more issues based on complexity and size of each of the one or more issues.

4. The computer-implemented method of claim 1, wherein recommending a queue further comprises:
processing, by the one or more processor, a context of the enriched one or more issues via NLP; and
placing, by the one or more processor, the enriched the one or more issues in a queue based on the context.

5. The computer-implemented method of claim 1, wherein priority parameters further comprises of a user created rules, goals, and other relationship, and wherein team parameters further comprises of teams and team members; and wherein queue parameters further comprises of queue item status and queue item points.

6. The computer-implemented method of claim 1, wherein creating a sprint plan further comprises:
calculating, by the one or more processor, the sprint plan based on at least a queue parameters and sprint parameters.

7. The computer-implemented method of claim 1, wherein the sprint parameters further comprises of velocity, percentage, effective velocity, method of distribution, the queue parameters, and the team parameters.

8. A computer program product for multi-sprint backlog management, the computer program product comprising:
one or more computer readable storage media and program instructions stored on the one or more computer readable storage media, the program instructions comprising:
program instructions to receive one or more issues associated with software development;
program instructions to score the one or more issues;
program instructions to determine if the score associated with the one or more issues is above a first threshold;
responsive to the one or more items is above the threshold, program instructions to enrich the one or more issues;
program instructions to recommend a queue based on the enriched one or more issues, team parameters and queue parameters;
program instructions to prioritize the enriched one or more issues in the queue based on priority parameters;
program instructions to calculate backlog value based on sprint factors associated with the enriched one or more issues;
program instructions to determine if the calculated backlog value is above a second threshold; and
responsive to the calculated backlog value is above the second threshold, program instructions to create a sprint plan based on sprint parameters.

9. The computer program product of claim 8, wherein enriching the one or more issues further comprises:
program instructions to tag the one or more issues with context based on NLP (natural language processing).

10. The computer program product of claim 8, wherein scoring the one or more issues further comprises:
program instructions to assign a value to each of the one or more issues based on complexity and size of each of the one or more issues.

11. The computer program product of claim 8, wherein recommending a queue further comprises:
program instructions to process a context of the enriched one or more issues via NLP; and
program instructions to place the enriched one or more issues in a queue based on the context.

12. The computer program product of claim 8, wherein priority parameters further comprises of a user created rules, goals, and other relationship; wherein team parameters further comprises of teams and team members; and wherein queue parameters further comprises of queue item status and queue item points.

13. The computer program product of claim 8, wherein creating a sprint plan further comprises:
program instructions to calculate the sprint plan based on at least a queue parameters and sprint parameters.

14. The computer program product of claim 8, wherein the sprint parameters further comprises of velocity, percentage, effective velocity, method of distribution, the queue parameters, and the team parameters.

15. A computer system for multi-sprint backlog management, the computer system comprising:
one or more computer processors;
one or more computer readable storage media; and
program instructions stored on the one or more computer readable storage media for execution by at least one of the one or more computer processors, the program instructions comprising:
program instructions to receive one or more issues associated with software development;
program instructions to score the one or more issues;
program instructions to determine if the score associated with the one or more issues is above a first threshold;
responsive to the one or more items is above the threshold, program instructions to enrich the one or more issues;
program instructions to recommend a queue based on the enriched one or more issues, team parameters and queue parameters;
program instructions to prioritize the enriched one or more issues in the queue based on priority parameters;
program instructions to calculate backlog value based on sprint factors associated with the enriched one or more issues;
program instructions to determine if the calculated backlog value is above a second threshold; and
responsive to the calculated backlog value is above the second threshold, program instructions to create a sprint plan based on sprint parameters.

16. The computer system of claim 15, wherein enriching the one or more issues further comprises:
program instructions to tag the one or more issues with context based on NLP (natural language processing).

17. The computer system of claim 15, wherein scoring the one or more issues further comprises:
program instructions to assign a value to each of the one or more issues based on complexity and size of each of the one or more issues.

18. The computer system of claim 15, wherein recommending a queue further comprises:
program instructions to process a context of the enriched one or more issues via NLP; and
program instructions to place the enriched one or more issues in a queue based on the context.

19. The computer system of claim 15, wherein priority parameters further comprises of a user created rules, goals, and other relationship; wherein team parameters further comprises of teams and team members; and wherein queue parameters further comprises of queue item status and queue item points.

20. The computer system of claim 15, wherein creating a sprint plan further comprises:
program instructions to calculate the sprint plan based on at least a queue parameters and sprint parameters.
